(19) United States
(12) Patent Application Publication
(10) Pub. No.: US 2019/0019293 A1
(43) Pub. Date: Jan. 17, 2019

(54) System and Method for Share of Shelf Data Capture and Analysis

(71) Applicant: BET INFORMATION SYSTEMS, INC., Boston, MA (US)

(72) Inventor: James A. Woodroffe, San Francisco, CA (US)

(73) Assignee: BET INFORMATION SYSTEMS, INC., Boston, MA (US)

(21) Appl. No.: 15/868,595

(22) Filed: Jan. 11, 2018

Related U.S. Application Data
(60) Provisional application No. 62/446,139, filed on Jan. 13, 2017.

(51) Int. Cl. G06T 7/13; G03B 37/04; G06T 7/33; G06T 7/90; G06K 9/46

(52) U.S. Cl. CPC G06T 7/13; G03B 37/04; G06T 2207/20221; G06T 7/90; G06K 9/4604; G06T 7/33

(57) ABSTRACT

A camera system and method captures and stitches images to display share-of-shelf information. The camera system superimposes a guide with the first image so that the camera is movable to align the first image with the guide. The system adds an edge demarcation to the captured first image displays the edge demarcation along with a second adjacent image of the shelf, so that the edge demarcation and the guide are usable to align and overlap common portions of the second image with the first modified image. The system captures the second image upon alignment of the second image with the guide and with the edge demarcation of the first modified image, to create a second modified image, the first modified image and the second modified image forming an aggregated image.

### RELATED APPLICATION

This application claims the benefit of U.S. Provisional Patent Application Ser. No. 62/446,139, entitled System and Method for Share of Shelf Data Capture and Analysis, filed on Jan. 1, 2017, the contents of which are incorporated herein by reference in their entirety for all purposes.

### BACKGROUND

### Technical Field

This invention relates to image generation and analysis, and more particularly to a system and method for capturing and stitching together multiple shelf images for automated share of shelf calculations.

### Background Information

Share of shelf is a metric that compares the facings of a given brand to the total facings positions available. A facing is a frontal view of a single package of a product on a fully stocked store shelf. Conventional approaches for determining share of shelf are labor intensive, involving a great deal of manual work, such as counting packages and sketching shelf layouts. Workers may attempt to take photographs of the shelves in order to avoid the need for sketches. However, the extreme aspect ratio of shelves, i.e., the long length relative to height, typically requires the capture of many separate photographs in order to cover the entire length of the shelf. Overlaps and/or gaps between the images provide opportunity for misstating the number of products, rendering suspect any share of shelf calculations using the multiple images. Conventional attempts to stitch the images into a single aggregated image have been unable to do so accurately, particularly as the number of images to be stitched increases.

A need exists for an improved system and method for share of shelf data capture, including non-panoramic image stitching of multiple shelf images.

### SUMMARY

In one aspect of the invention, a camera system is provided for capturing and stitching together multiple stacked shelf images for generating and displaying share-of-shelf information. The camera system includes a body having a hand-held form factor, an electronic image capture device, an image display device, a storage device, and a processor disposed within the body. The processor is communicably coupled to the image capture device, the image display device, and the storage device. The display device is configured to (i) display a first image of a first horizontal stacked shelf portion, and a graphical user interface (GUI) module is configured to (ii) superimpose a GUI with the first image in the display device. The GUI includes a guide, e.g., a guideline generated by the GUI, disposed in fixed relation to the body, so that the body is movable to align the first image with the guide. The system is configured to (iii) capture the first image upon alignment of the first image with the guide, and to add an edge demarcation to the captured first image to create a first modified image, and to store the first modified image in the storage device. In particular embodiments, the edge demarcation includes a blurred edge portion. The GUI is configured, in response to storage of the first modified image, to (iv) display the edge demarcation of the first modified image in the display device along with the guide and along with a second image of a second horizontal stacked shelf portion. The second horizontal stacked shelf portion is adjacent to the first horizontal stacked shelf portion, so that the edge demarcation and the guide are usable to align and overlap common portions of the second image with the first modified image prior to capture of the second image. The system is configured to (v) capture the second image upon alignment of the second image with the guide and with the edge demarcation of the first modified image, to create a second modified image, and to store the second modified image in the storage device, so that the first modified image and the second modified image form an aggregated image.

The system also includes a product identification module including a stored program executable by the processor to identify individual products within the aggregated image by: converting any colored image portions within the aggregated image into black and white to generate a black and white version of the aggregated image (b&w image); inverting pixels of the b&w image to create an inverted black and white version of the aggregated image (inverted b&w image) and computing an average intensity for each horizontal line of inverted pixels, e.g., using a peak detection algorithm, to highlight shadows beneath each stacked shelf; dividing each row of the inverted b&w image into a plurality of horizontally spaced divisions using a Probabilistic Hough Line Detection algorithm to identify images of individual products (product images) on each stacked shelf; and mapping the product images to the aggregated image and highlighting each of the product images in the aggregated image to illustrate a total horizontal distance occupied by each product on the stacked shelves. In variations of the foregoing, the camera system includes a color matching module to match colors in the second image with the first modified image, e.g., highlighting the matched colors on the display, to help the user align and overlap the common portions of the images.

In further variations, the camera system is configured to repeat (i) through (v) for multiple images so that the first and second images comprise N^{th} and N+1^{th} images, respectively, to form said aggregated image, e.g., corresponding to an entire length of horizontal stacked shelves.

In particular embodiments, the camera system is configured to subdivide each of the horizontally spaced divisions using the Probabilistic Hough Line Detection algorithm to identify additional product images on each stacked shelf.

In further variations of the foregoing, the camera system employs a logo detection algorithm to identify trademarks and/or logos in the product images. The system may also highlight each identified product by placing a box around each of the product images.

In another aspect of the invention, a method is provided for capturing and stitching together multiple stacked shelf images for generating and displaying share-of-shelf information. The method includes providing a camera system including a body having a hand-held form factor, an electronic image capture device, an image display device, a storage device, and a processor disposed within the body. The processor is communicably coupled to the image capture device, the image display device, and the storage device. The method also includes configuring the display device to (i) display a first image of a first horizontal stacked shelf portion, configuring a graphical user interface (GUI) module to (ii) superimpose a GUI with the first image in the display device, and to include a guide, e.g., a guideline generated by the GUI, disposed in fixed relation to the body, so that the body is movable to align the first image with the guide. The method further includes configuring the system to (iii) capture the first image upon alignment of the first image with the guide, and to add an edge demarcation to the captured first image to create a first modified image, and to store the first modified image in the storage device. In particular embodiments, the edge demarcation includes a blurred edge portion. Additional steps include configuring the GUI, in response to storage of the first modified image, to (iv) display the edge demarcation of the first modified image in the display device along with the guide and along with a second image of a second horizontal stacked shelf portion. The second horizontal stacked shelf portion is adjacent to the first horizontal stacked shelf portion, so that the edge demarcation and the guide are usable to align and overlap common portions of the second image with the first modified image prior to capture of the second image. Still further steps include: configuring the system to (v) capture the second image upon alignment of the second image with the guide and with the edge demarcation of the first modified image, to create a second modified image, and to store the second modified image in the storage device, so that the first modified image and the second modified image form an aggregated image.

The method also includes providing the system with a product identification module including a stored program executable by the processor to identify individual products within the aggregated image by: converting any colored image portions within the aggregated image into black and white to generate a black and white version of the aggregated image (b&w image); inverting pixels of the b&w image to create an inverted black and white version of the aggregated image (inverted b&w image), and computing an average intensity for each horizontal line of inverted pixels, e.g., using a peak detection algorithm, to highlight shadows beneath each stacked shelf; dividing each row of the inverted b&w image into a plurality of horizontally spaced divisions using a Probabilistic Hough Line Detection algorithm to identify images of individual products (product images) on each stacked shelf; and mapping the product images to the aggregated image and highlighting each of the product images in the aggregated image to illustrate a total horizontal distance occupied by each product on the stacked shelves.

In variations of the foregoing, a color matching module matches colors in the second image with the first modified image, e.g., highlighting the matched colors on the display, to help the user align and overlap said common portions.

In further variations, the method includes configuring the camera system to repeat (i) through (v) for multiple images so that the first and second images comprise N^{th} and N+1^{th} images, respectively, to form said aggregated image, e.g., corresponding to an entire length of horizontal stacked shelves.

In particular embodiments, the method includes configuring the camera system to subdivide each of the horizontally spaced divisions using the Probabilistic Hough Line Detection algorithm to identify additional product images on each stacked shelf.

Further variations of the foregoing method include configuring the camera system to employ at least one logo detection algorithm to identify trademarks and/or logos in the product images. The system may also be configured to highlight each identified product by placing a box around each of the product images.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1A is a screen capture of a Graphical User Interface generated by an embodiment of the present invention;

FIG. 1B is an image displayed by an embodiment of the present invention;

FIG. 1C is another image displayed by an embodiment of the present invention;

FIG. 1D is a schematic front elevational view of a device embodying aspects of the present invention;

FIG. 1E is a schematic side elevational view of the device of FIG. 1D;

FIG. 2 is a series of sequential images captured by an embodiment of the present invention;

FIG. 3A is a representative image generated during a step in the operation of an embodiment of the present invention;

FIG. 3B is a representative image generated during a step in the operation of the embodiment of FIG. 3A;

FIG. 4 is a representative image generated during a step in the operation of the embodiment of FIGS. 3A and 3B;

FIG. 5 is a graphical representation of a step in the operation of the embodiment of FIGS. 3A-4;

FIG. 6 is a graphical representation of a step in the operation of the embodiment of FIGS. 3A-5;

FIG. 7A is a representative image generated during a step in the operation of the embodiment of FIGS. 3A-6;

FIG. 7B is a representative image generated during a step in the operation of the embodiment of FIGS. 3A-7A;

FIG. 7C is a representative image generated during a step in the operation of the embodiment of FIGS. 3A-7B;

FIG. 8 is a representative image and graphical user interface generated during a step in the operation of the embodiment of FIGS. 3A-7C;

FIG. 9 is a representative image and graphical user interface generated during a step in the operation of the embodiment of FIGS. 3A-8;

FIG. 10 is an alternate representative image generated by embodiments of the present invention; and

FIG. 11 is a block diagram of one embodiment of a computer system usable with embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

A method and apparatus is provided for enabling multiple electronic images to be stitched together and analyzed to produce metrics and visualizations regarding product positioning, also known as ‘share of shelf’. Previous approaches of image stitching were not accurate enough to be useful in this type of application. Embodiments of the present invention have addressed the technical problems of conventional approaches to provide stitched images that are sufficiently accurate to provide for automation of aspects of the share of shelf analysis process.

Briefly described, embodiments of the present invention involve:
1. Field Work
   1.1. Worker is assigned a location (or selects a location from a target list)
   1.2. Worker visits store and takes a structured series of photographs (or structured video)
2. Systems work
   2.1. Photos or video are processed to create single unified view “panoramic like” view of the shelf or aisle in question
   Step is performed by customized software performing complex calculations to correct for photographic differences compared to standard scenic panoramic photos
   2.2. Photos are marked up to visually indicate an individual product location
   2.3. The individual marked up locations are then processed to identify product (and other attributes) at the specific location
3. Final Output
   3.1. A stylized abstract visual rendering can be produced with the rendering of the shelf
   3.2. This data can be mathematically analyzed to compare different stores en mass or individually
   3.3. Different layouts can be compared against sales data
   3.4. Layouts can be compared against contracted positioning

Terminology

As used in the specification and in the appended claims, the singular forms “a”, “an”, and “the” include plural referents unless the context clearly indicates otherwise. For example, reference to “an analyzer” includes a plurality of such analyzers. In another example, reference to “an analysis” includes a plurality of such analyses.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As used herein, the terms “computer” and “end-user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “component”, “module”, and the like are intended to refer to a computer-related entity, including hardware or a combination of hardware and, software. For example, an engine may be, but is not limited to being: a process running on a processor; a processor including an object, an executable, a thread of execution, and/or program; and a computer. Moreover, the various computer-related entities may be localized on one computer and/or distributed between two or more computers.

### Programming Languages

The system and method embodying the present invention can be programmed in any suitable language and technology, such as, but not limited to: Assembly Languages, C, C++; Visual Basic; Java; VBScript; Jscript; Node.js; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

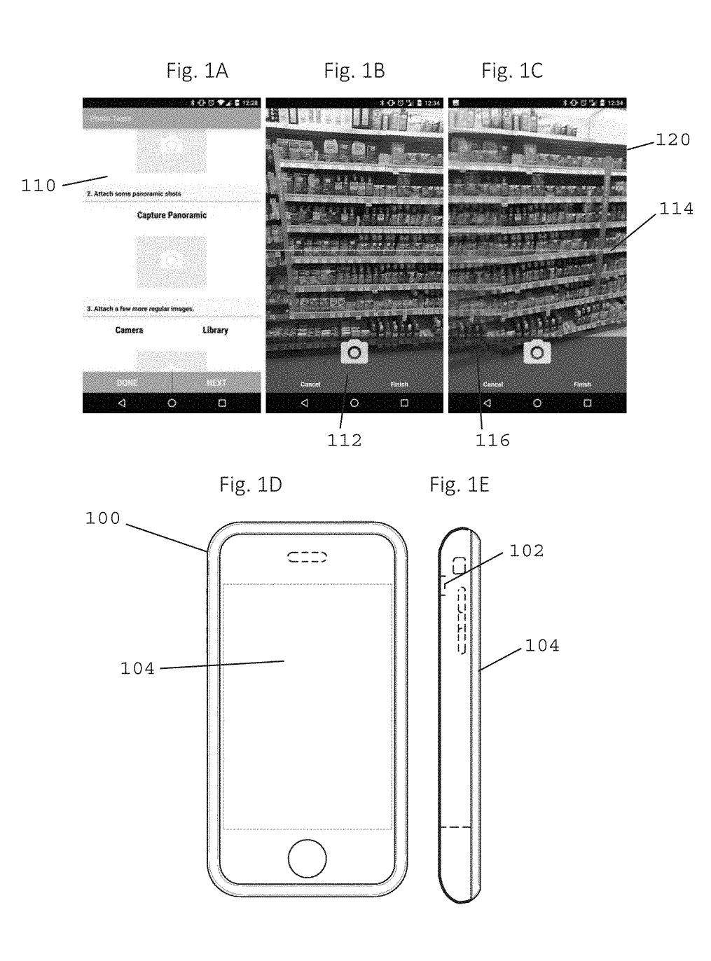

Referring now to FIGS. 1-11, embodiments of the present invention will be more thoroughly described. Initially, it should be recognized that embodiments of the present invention are intended to help users understand the physical layout of products on a shelf down to the row, column, shelf number, and other attributes such as price and in-stock and out-of-stock. The process starts with the user visiting a store, e.g., using a mobile application on their mobile device taking a series of pictures to capture entire shelves using a structured photograph environment. Turning to FIGS. 1A-1E, the system, embodiments of the present invention include a camera system 100 with a hand-held form factor, such as in the form of a cellphone as shown in FIGS. 1D, 1E, an electronic image capture device 102, an image display device 104, a storage device 304 (FIG. 12), and a processor 302 (FIG. 12) communicably coupled thereto. A graphical user interface (GUI) module is configured to display a GUI on the image display device 104, e.g., as shown at 110 (FIG. 1A).

The camera system 100 is configured, via instructions 326, e.g., in the form of a smartphone app, stored in memory 304 (FIG. 12), to generate a graphical user interface (GUI) screen 110 as shown in Fig. lA that permits a user to display a first image 112 of a first horizontal stacked shelf portion, such as shown in FIG. 1B. The system is configured to capture the first image 112, e.g., upon alignment of the first image with a guide 114. As shown guide 114 may take the form of a guideline generated by the GUI module 106, which is disposed in fixed relation to the body of camera system 100, so that the body is movable by the user to align the first image 112 with the guideline. In the particular embodiment shown, guideline 114 is intended to be aligned in parallel orientation with the horizontal shelves.

In addition to the guideline(s) 114, the system may optionally provide additional indicators and/or skew checkers to help the user get the camera squared up relative to the shelf. In the example shown in FIG. 1B, the guideline 114 takes the form of a white line running horizontally across the displayed image, and appears to be parallel to the shelves, indicating that the user did a good job of aligning the camera prior to capturing the image 112. On the other hand, in FIG. 1C, one can see that the white horizontal guideline 114 is not parallel to the shelves, indicating that the user needs to rotate the camera counterclockwise or otherwise reorient the camera before capturing the next image.

As also shown in FIG. 1C, the system 100 is configured to add an edge demarcation 116 (FIG. 1C) to the captured first image 112 to create a first modified image, and to store the first modified image in the storage device 304. In the embodiments, the edge demarcation includes a soft overlay, i.e., a fuzzy or blurred edge portion. Indeed, as shown in FIG. 1C, the GUI is configured, in response to storage of the first modified image, to display the edge demarcation 116 of the first modified image in the display device 104 along with the guide 114 and along with a second image 120 of a second horizontal stacked shelf portion. The idea is to get the user to take the second photo in such a way that it directly overlaps with the previous photo so the photos can ultimately be combined as discussed in greater detail hereinbelow. In this regard, the edge demarcation 116 is shown on the left side of the display in FIG. 1C, so that it may be overlapped with the left side of the second image 120. This overlapping, along with guide 114, enable the user to accurately align the second image 120 with the first modified image prior to capture of the second image. The system is thus configured to capture the second image upon alignment of the second image with the guide and with the edge demarcation of the first modified image, to create a second modified image, and to store the second modified image in the storage device 304, so that the first modified image and the second modified image form an aggregated image, as discussed in greater detail hereinbelow.

It should be noted that the application of the edge demarcation (e.g., fuzzing/blurring) 116 to create a modified image to facilitate alignment and aggregation with an adjacent image was developed by the instant inventors. This approach was specifically developed in order to address the particular complexities encountered with attempting to produce an aggregated photograph that may be successfully deconstructed to generate accurate share of shelf information, as will be discussed in greater detail hereinbelow. It should also be noted that this approach is distinct from conventional panoramic photo generation in which the user is generally stationary, i.e., capturing images while turning to face different directions from a single location. The embodiments hereof, on the other hand, contemplate the user capturing images from multiple locations, e.g., while moving laterally down the aisle along the length of the shelf. Moreover, those skilled in the art should recognize that the teachings hereof may be implemented with a rapid-fire stream of photos, or even video, that may be automatically captured, e.g., with a robot moving down the aisle or using footage captured from a store's security cameras.

Turning back to FIG. 1C, the image shown at 120 is what the user is seeing in the viewfinder (display) prior to capturing the image. The fuzzy or blurred portion on the left side is the right side of the previously captured photo of FIG. 1B. The system provides this in the viewfinder to help the user align the camera so that the subsequently captured photograph overlaps with the previously captured photograph. In this manner, embodiments of the invention facilitate capturing a series of photos that are substantially equivalently focused and laid out. This approach, along with the white horizontal guideline enables the user to capture photographs of the shelves without double capturing products. The system may also employ color matching (e.g., of products within the images), as discussed in greater detail hereinbelow to help identify areas of overlap between images, to facilitate stitching of the images to one another for image aggregation.

In operation, once the user takes the first photo, the system automatically moves on to the next. In the example shown, the user starts at the left-hand side of a cold and flu aisle within a pharmacy, and then moves sequentially down the aisle to the right, until the entire aisle has been photographed. So the user takes the first photo and then instead of having to guess where to take the next one from, the system provides guidance in the form of the edge demarcation/blurred portion 116 of the previous photo, along with the white horizontal guideline 114, to help capture the next overlapping photo.

The user thus takes the photo shown in FIG. 1B and then as the user moves the camera down the shelf, the system superimposes a portion of the previous (FIG. 1B) image onto the viewfinder as shown in FIG. 1C. As shown, the system blurs or otherwise demarks the overlap between the previously captured image and the new content displayed in the viewfinder. This process is repeated for multiple images until the entire aisle or series of aisles in the store is captured and stored in a single aggregated image as discussed hereinbelow. Any number N of images may be aggregated in this fashion, with some embodiments using from 1 to 20, 30, 40 or 50 or more images, i.e., N=1 to 50 or more. This approach enables a user to capture all of the aisles in a store in a matter of minutes, rather than spending potentially hours in a store with a clipboard or an excel spreadsheet typing in every single item on the shelves.

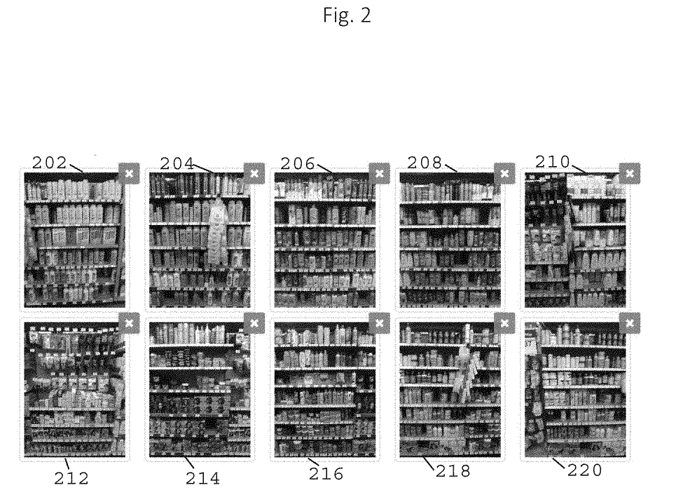

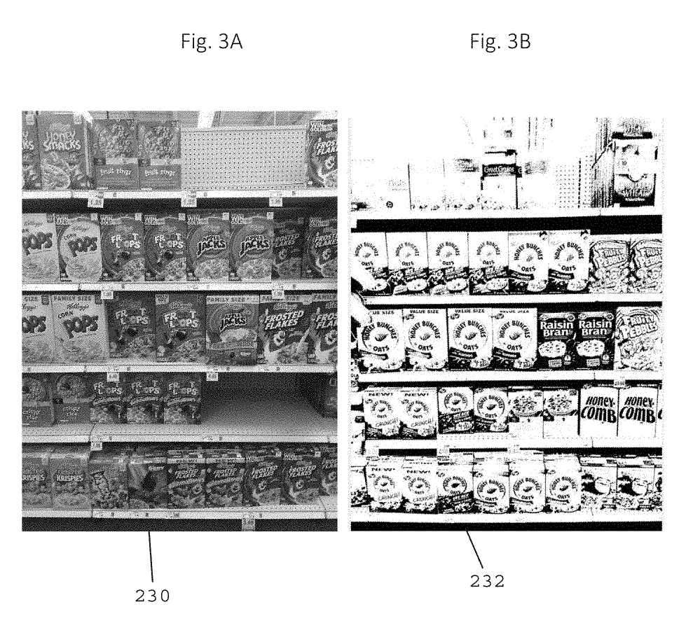

Turning now to FIG. 2, the image aggregation (i.e., image stitching) performed by the system is shown and described in greater detail. FIG. 2 includes a series of images 202-220 captured by a user, using the approach shown and described hereinabove with respect to FIGS. 1A-1C. The system is configured to combine these images into a single aggregated image (photo), such as shown at 230, 230′, and 230″ in FIGS. 3A, 7B, and 8, respectively. As discussed hereinabove, it should be noted that this aggregated photo is not simply a paired photo, but rather, is a unified photo that accurately lines up all the shelves and ensures that the products on the shelves are not double-counted or double-marked in subsequent steps. Moreover, it should be recognized that for ease of explication, the aggregated images 230, 230′ and 230″ are shown as being relatively short in horizontal length. However, as mentioned above, in particular applications, the aggregated images are intended to be long enough to include an entire horizontal length of stacked shelves including tens of individual images. Indeed, a single aggregated image may include multiple lengths of shelves containing 50 or more individual images.

It should be noted that the instant inventor has recognized that from a technological standpoint, the process of stitching individual images into a aggregated image is significantly more complex than conventional cellphone camera (e.g., iPhone®, Apple Inc.) panoramics. Moreover, the complexity of stitching multiple photos together may be orders magnitude greater than simply combining two photos. Conventional software for stitching two photos together tends to work relatively well for two photos but it breaks down rapidly as a third or fourth photo is added, let alone ten or more as in many embodiments of the present invention.

In particular embodiments, the aforementioned image aggregation uses conventional non-panoramic image stitching, e.g., of the type commonly used to combine two photos to one another, modified as described hereinabove to facilitate the combination of multiple photos. These embodiments effectively leverage conventional two-photo image stitching to enable a larger number of images to be aggregated in a computationally practical manner. In particular, the use of the aforementioned guidelines and blurred edge portions help the user align the image prior to its capture, while the blurred edges also help the system locate the overlapping portions of captured images for stitching. Particular embodiments also leverage the fact that each of the captured images, as properly aligned using the guidelines and blurred edges, includes a visually significant horizontal feature (i.e., the shelf). This horizontal feature is used by the system to help align adjacent images with one another during the stitching process. Embodiments may also employ color matching (e.g., of products within the images) to help identify areas of overlap between adjacent images and facilitate stitching for image aggregation. In particular embodiments, this color matching may be effected by a color matching module configured to identify similar colors in adjacent images, e.g., highlighting the matched colors on the display, to help the user align and overlap the common portions of the images. The color matching module may include any number of commercially available tools, such as the ColorSnap® Visualizer for iPhone and Android, available from The Sherwin-Williams Company (Cleveland, Ohio), e.g., in the form of additional instructions 326 in the form of a smartphone app stored in memory 304 (FIG. 12). Once colors in adjacent images are matched, they may be highlighted on the display to enable the user to move them into alignment with one another.

Once we have the large aggregated photo, the system 100 identifies each product location. Turning now to FIGS. 2-8, next steps in the process will be described. The instant inventor has recognized that product identification within the aggregated electronic image may be accomplished automatically with relatively high accuracy and efficiency by using computer vision technologies in a manner that takes advantage of the physical nature of shelving and in-store lighting. These embodiments leverage these aspects to produce effects that are easily and efficiently discernable via automated electronic vision analysis to generate results more reliably than conventional line detection or feature extraction methods. For example, as shown and described hereinabove with respect to FIG. 2, the user takes a series of individual overlapping pictures of a shelf, beginning at one end and continuing until the entire shelf has been photographed. As also discussed hereinabove, each of the individual photos is aligned so that the bottom of the frame is parallel to the shelf (parallel to the floor).

The system then identifies the products within the photographs. Particular embodiments identify the products within the aggregated image, although products may be identified within the individual images prior to aggregation, without departing from the scope of the present invention. A representative product identification approach will now be described in detail, with respect to images that may either be portions of an aggregated image, or individual pre-aggregation images.

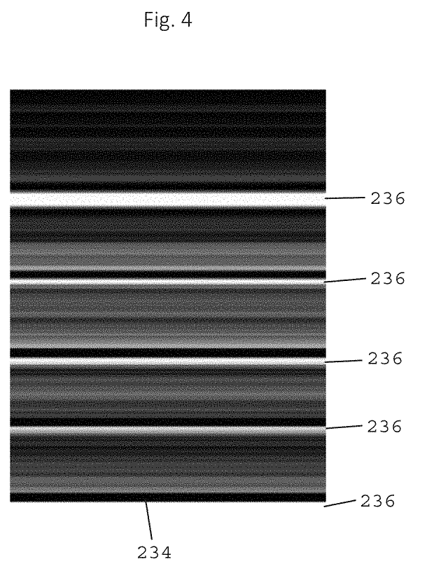

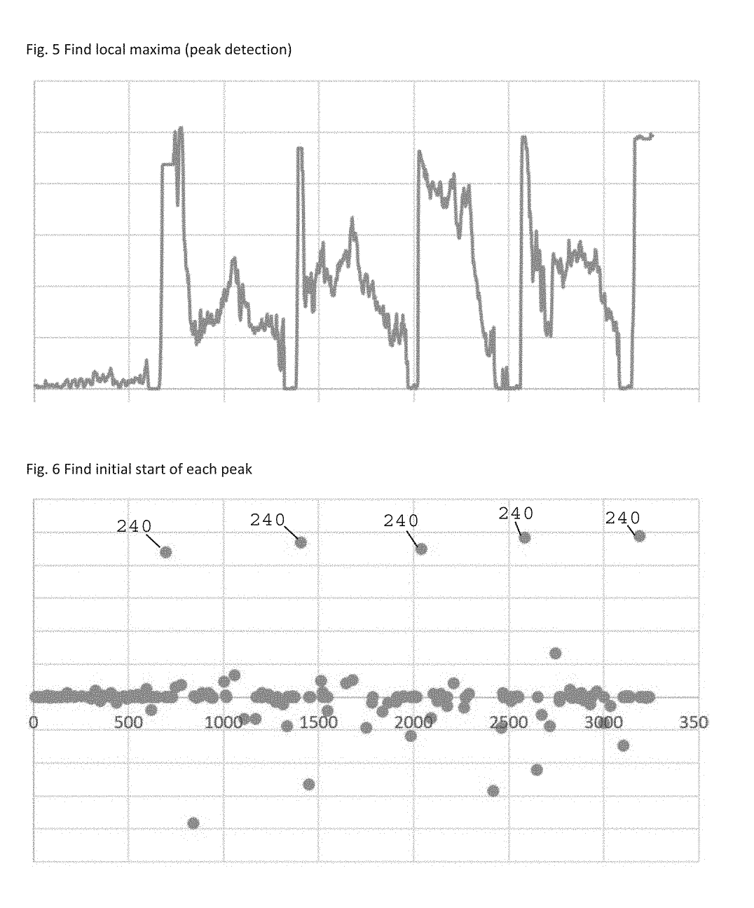

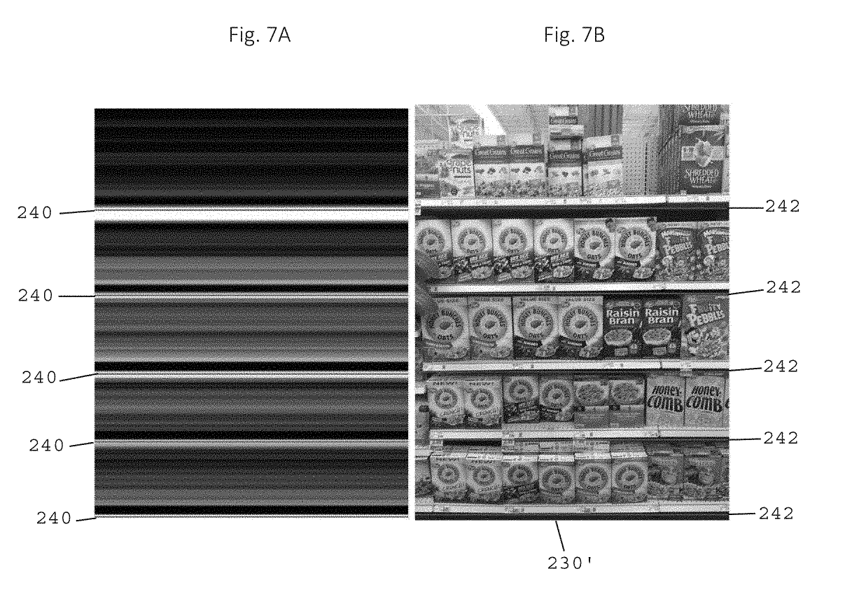

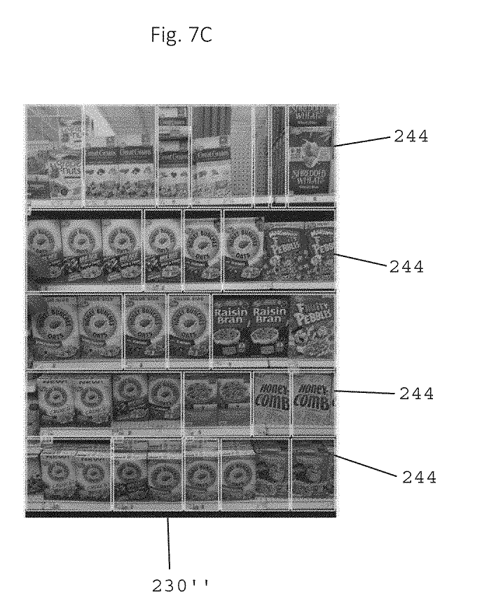

These embodiments convert colored image portions within the aggregated image 230 of the shelf, shown in FIG. 3A, into a black and white version 232 as shown in FIG. 3B. (It should be noted that the colored portions of the aggregated image 230 may be converted to black and white before or after the colored portions are merged into the aggregated image 230 without departing from the scope of the present invention.) The system 100 then inverts the black and white colors and computes the average color for each horizontal line of pixels in the image. A representative result of this computation is shown as image 234 of FIG. 4. It should be noted that the system inverts the black and white colors to take advantage of typical overhead retail store lighting which creates shadows immediately beneath the shelves. The black and white inversion effectively filters out the relatively light colored (e.g., white) products, which constitute the vast majority of the content in the image(s). This has the effect of essentially filtering the image to highlight the shadows beneath the shelves which now has relatively high intensity (e.g., white) pixels, as shown at 236. Embodiments of the system use a conventional peak detection algorithm, such as provided by the Matlab r2016b system commercially available from MathWorks® Inc., (Natick, Mass.), to find local maxima of white pixels as shown in the in the graph of FIG. 5, and then identifies the initial start of each peak, as shown in FIG. 6. In FIGS. 5 and 6, the intensity of these peak pixels is shown on the y-axis, while the x-axis corresponds to the horizontal line of pixels in the image. Thus, the peaks of FIG. 5 and their corresponding starting points shown at the upper portion of FIG. 6 at 240, correspond to the pixel rows of the shelves in the image, beginning with the uppermost shelf and moving towards the bottom of the image, such as shown at lines 240 in the average pixel intensity image of FIG. 7A, and the dark shadow areas beneath the shelves shown at 242 of aggregated image 230′ of FIG. 7B.

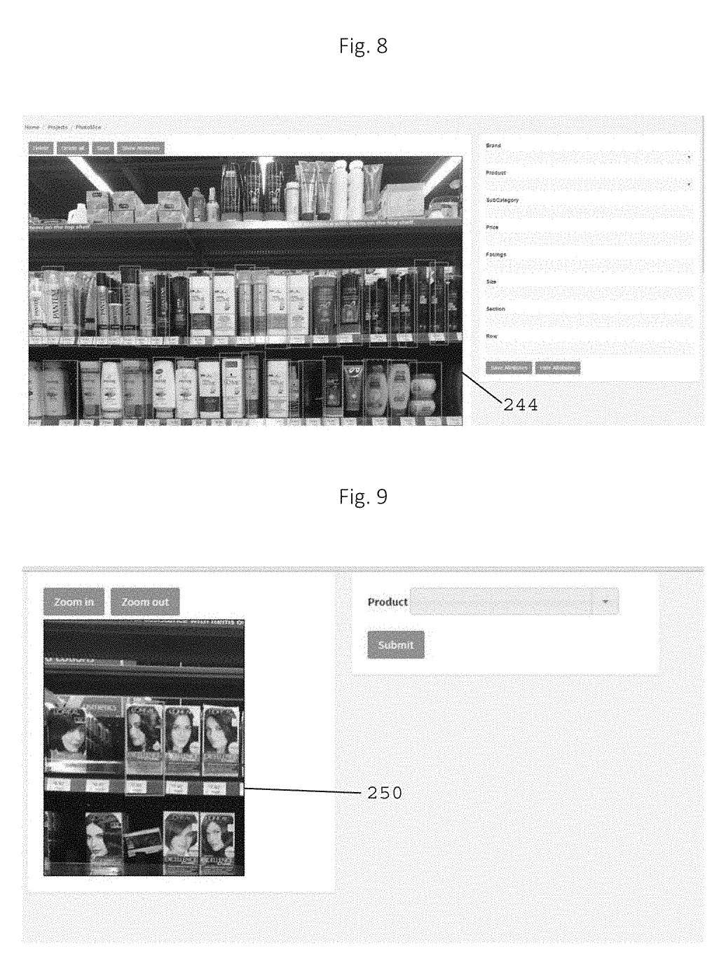

Once the shelves have been identified, embodiments of the system begin to identify individual products on the shelves by dividing each row into one or more horizontally spaced divisions, e.g., using one or more conventional Probabilistic Hough Line Detection algorithms. The individual products located in this manner are then highlighted, e.g., by superimposing boxes 244 onto the aggregated image as shown in FIGS. 7C and 8. It should be recognized that this process may be repeated on a more granular level, e.g., for each of the superimposed boxes, to identify any instances of multiple products within the boxes. For example, a Probabilistic Hough Line Detection algorithm is used to make the first pass at creating horizontally spaced divisions in the row. After the first pass, the system makes a series of additional passes. In this example, the second pass looks at divisions that appear to be relatively large, e.g., too large for typical products, and uses a more granular version of a Probabilistic Hough Line Detection algorithm to identify locations of further divisions. A third pass may then take all the “products” that were found in the previous passes and dynamically look for them within all the remaining “too large” divisions. The third pass may use one of various “interest point” detection algorithms to compute inlier thresholds. Exemplary interest point detection algorithms useful in embodiments of the present invention include the Computer Vision System Toolbox™ algorithms in the Matlab r2016b system commercially available from MathWorks®. Based on these results, a final row of products is identified.

Once the products have been identified, particular embodiments of the system may employ logo detection algorithms to identify trademarks/logos on the product packaging. An example of a logo detection algorithm that may be used with these embodiments is provided in the Computer Vision suite available from Google, Inc. (Mountain View, Calif.). These logos may be used to help confirm the identity of particular suppliers' products, for reporting purposes, etc.

Turning now to FIG. 8, the identification of particular products, and highlighting them, e.g., with boxes 244 in the aggregated image, illustrates, in the context of store presence merchandising, the product's shelf presence or ‘share of shelf’. The product images are highlighted in the aggregated image to illustrate a total horizontal distance occupied by each product on the stacked shelves. Note that in the embodiment shown, we only care about the cross-wise (e.g., horizontal) spacing on each shelf. In other words, what we care about and what the stores and the product manufacturers care about is how much horizontal space a product takes up per shelf. Thus, as discussed hereinabove, particular embodiments provide this identification of the product's shelf presence, including the identification of individual products and/or drawing of the boxes 244 around them, using conventional edge detection algorithms modified in accordance with the teachings of the present invention. Other conventional algorithms useful in embodiments hereof include the emboss feature on conventional photo processing software, that turns objects into black and white outlines using conventional edge detection. The present invention uses a version of this conventional edge detection that has been modified in accordance with the teachings hereof in order to deal with the complexity of the aggregated photo and of the large number and disparate sizes, shapes, and graphics associated with retail shelf space analysis. In this regard, to summarize the foregoing, these embodiments apply some physical knowledge about the space, including conventional retail shelf layouts, products, and lighting, etc., in order to provide the required sophistication that exceeds that of simple edge detection or black and white embossing algorithms. These embodiments thus begin with the core layout of the shelf, looking for large-scale linear patterns including strong lines extending substantially horizontally across the aggregated photo, and then look for spaced perpendicular lines that would subdivide relatively large percentages of the available space along the horizontal lines. So the system effectively takes an outside-in perspective of the aggregated photo, to turn the photo into a grid layout of square or rectangular boxes, in which each box corresponds to a product on the shelf. With this grid layout, the system then identifies the particular product located in each box, and then determines other attributes of interest, such as product brand, type, size, price, etc.

Turning now to FIG. 9, examples of the attributes of interest that may be captured by the system 100 include the brand (e.g., L'Oreal), product type (hair dye), name (Excellence), price ($7.97), product size, and UPC codes, etc., as displayed at 250. At this point in the process, i.e., once the system has generated the aggregated photo and overlayed the photo with the aforementioned grid, embodiments of the invention may capture these additional product attributes using conventional image and/or logo recognition algorithms as discussed hereinabove.

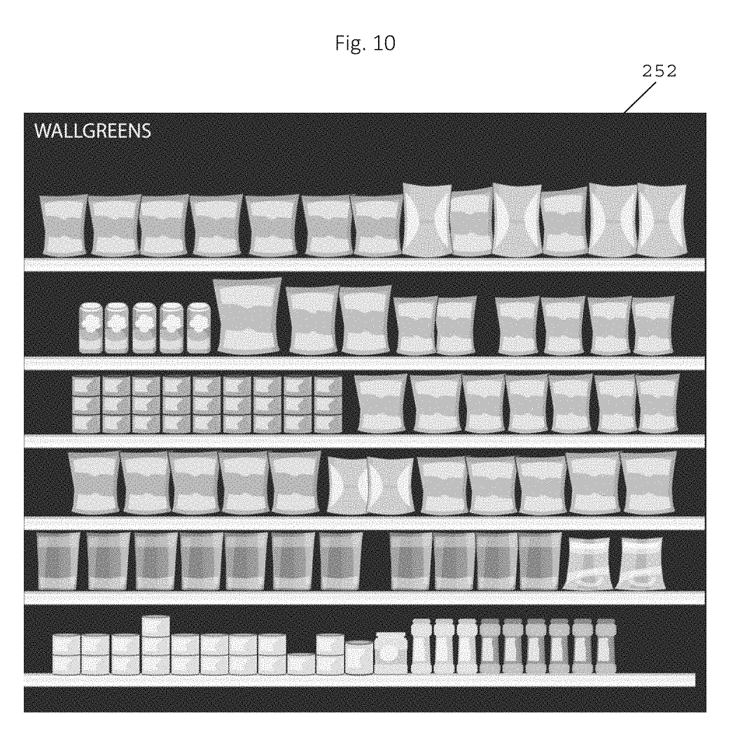

FIG. 10 is an example of what the system 100 can do with the data captured in the foregoing operations. As shown, embodiments of the invention produce a stylized layout 252 that facilitates understanding the shelf. In this example, the color purple is used to denote brand X, orange denotes brand Y, and green is the store brand. This view enables one to easily see that the store brand is interspersed with the brand Y products, which is not supposed to happen. Rather, the store brand should be located on its own portion of the shelf. These embodiments thus permit the retailer of a company to easily view and then compare the placement of its product on the shelf, and view how the store brand looks relative to it. In this case, the actual placement indicates that brand Y and the store brand look very similar, and that brand Y is probably losing sales to people not paying close attention.

Thus, from this stylized view, which is determined from the grid zoning information discussed above, the user may compare and contrast different stores, both numerically and visually. Layout 250 may include parameters captured from FIGS. 8 and 9 that are abstracted, e.g., into colors and shapes, etc. The choice of colors and other abstractions applied is up to the user. As another example, the color green could be applied to all competitive-priced items, with other colors used to denote higher end or lower end or otherwise non-competitive items.

A method 400 for capturing and stitching together multiple stacked shelf images for generating and displaying share-of-shelf information, will now be described as illustrated by the following Table I.

As shown at 402, the method includes providing a camera system 100 as shown and described hereinabove. At 404, the display device is configured to (i) display a first image of a first horizontal stacked shelf portion disposed within its field of vision. At 406, the graphical user interface (GUI) module is configured to superimpose a GUI with the first image in the display device, and to include at least one guide disposed in fixed relation to said body, wherein the body is movable to align the first image with the guide. At 408, the system 100 is configured to capture the first image upon alignment of the first image with the guide, and to add at least one edge demarcation to the captured first image to create a first modified image, and to store the first modified image in the storage device. At 410, the GUI is configured, in response to storage of the first modified image, to display the edge demarcation of the first modified image in the display device along with the guide, and along with a second image of a second horizontal stacked shelf portion disposed within the field of vision. The second horizontal stacked shelf portion is adjacent to the first horizontal stacked shelf portion, wherein the edge demarcation and the guide are usable to align and overlap common portions of the second image with the first modified image prior to capture of the second image. At 412, the system is configured to capture the second image upon alignment of the second image with the guide and with the edge demarcation of the first modified image, to create a second modified image, and to store the second modified image in the storage device, wherein the first modified image and the second modified image form an aggregated image. At 414, a product identification module is configured to identify individual products within the aggregated image by: (a) converting colored image portions within the aggregated image into a black and white version of the aggregated image (b&w image); (b) inverting pixels of the b&w image to create an inverted black and white version of the aggregated image (inverted b&w image), and computing an average intensity for each horizontal line of inverted pixels using a peak detection algorithm, to highlight shadows beneath each stacked shelf which are indicated by relatively high intensity pixels; (c) dividing each row of the inverted b&w image into a plurality of horizontally spaced divisions using at least one Probabilistic Hough Line Detection algorithm to identify images of individual products (product images) on each stacked shelf; and (d) mapping the product images to the aggregated image and highlighting each of the product images in the aggregated image to illustrate a total horizontal distance occupied by each product on the stacked shelves.

TABLE I

| | |
|---|---|
| 402 | camera system 100 provided |
| 404 | display device configured to display a first image of a first |
| | horizontal stacked shelf portion. |
| 406 | GUI module configured to superimpose a GUI with the first image |
| | in the display device, and to include a guide disposed in fixed |
| | relation to the body. |
| 408 | system 100 configured to capture the first image upon alignment |
| | with the guide, add edge demarcation, and store first modified |
| | image. |
| 410 | GUI configured to display the edge demarcation of the first |
| | modified image along with both the guide and a second image of a |
| | second horizontal stacked shelf portion. |
| 412 | the system configured to capture the second image upon alignment |
| | with the guide and the edge demarcation of the first modified |
| | image, to create a second modified image, and to form an |
| | aggregated image. |
| 414 | identify individual products within the aggregated image by: |
| | (a) converting colored image portions to black and white; |
| | (b) inverting pixels of the b&w image; |
| | (c) dividing each row of the inverted b&w image into horizontally |
| | spaced divisions using Probabilistic Hough Line Detection |
| | algorithm; and |
| | (d) highlighting each of the product images in the aggregated |
| | image. |

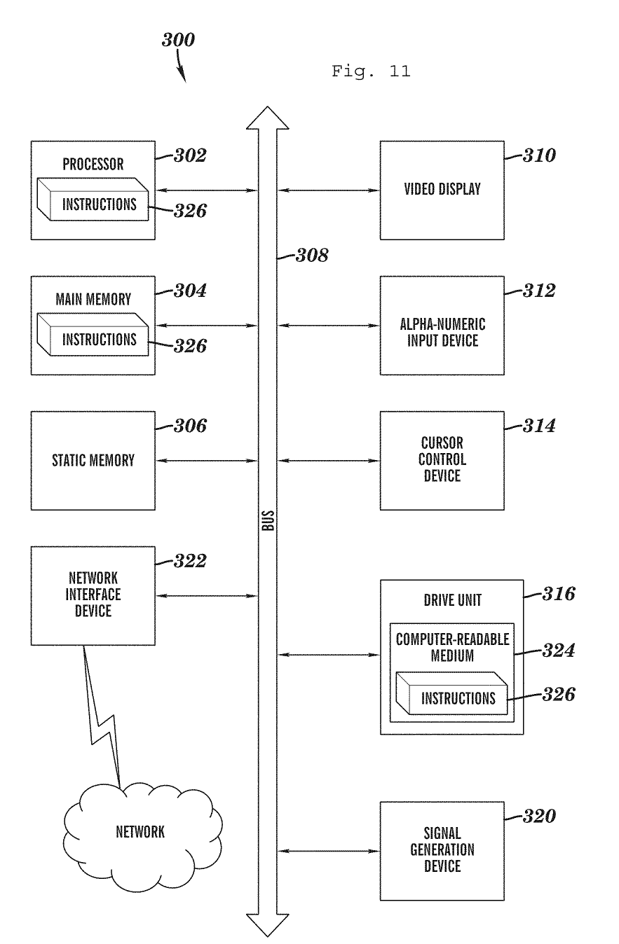

FIG. 11 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention, and as further described hereinbelow.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

Embodiments of the present invention also relate to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible, non-transitory, computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), any other appropriate static, dynamic, or volatile memory or data storage devices, or other type of media suitable for storing electronic instructions, and each coupled to a computer system bus. Furthermore, the computers referred to in the specification may include a single processor or may be architectures employing multiple processor designs for increased computing capability.

Various systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims. It should be further understood that any of the features described with respect to one of the embodiments described herein may be similarly applied to any of the other embodiments described herein without departing from the scope of the present invention.

Having thus described the invention, what is claimed is:

1. A camera system for capturing and stitching together multiple stacked shelf images for generating and displaying share-of-shelf information, the system comprising:
a body having a hand-held form factor;
an electronic image capture device having a field of vision, an image display device, a storage device, and a processor, disposed within said body, the processor communicably coupled to the image capture device, the image display device, and the storage device;
the display device configured to (i) display a first image of a first horizontal stacked shelf portion disposed within the field of vision;
a graphical user interface (GUI) module configured to (ii) superimpose a GUI with the first image in the display device;
the GUI including at least one guide disposed in fixed relation to said body, wherein the body is movable to align the first image with the guide;
the system configured to (iii) capture the first image upon alignment of the first image with the guide, and to add at least one edge demarcation to the captured first image to create a first modified image, and to store the first modified image in the storage device;
the GUI configured, in response to storage of the first modified image, to (iv) display the edge demarcation of the first modified image in the display device along with the guide and a second image of a second horizontal stacked shelf portion disposed within the field of vision, the second horizontal stacked shelf portion being adjacent to the first horizontal stacked shelf portion, wherein the edge demarcation and the guide are usable to align and overlap common portions of the second image with the first modified image prior to capture of the second image;
the system configured to (v) capture the second image upon alignment of the second image with the guide and with the edge demarcation of the first modified image, to create a second modified image, and to store the second modified image in the storage device, wherein the first modified image and the second modified image form an aggregated image; and
the system including a product identification module including a stored program executable by the processor, the stored program configured to identify individual products within the aggregated image by:
converting any colored image portions within the aggregated image into black and white to generate a black and white version of the aggregated image (b&w image);
inverting pixels of the b&w image to create an inverted black and white version of the aggregated image (inverted b&w image), and computing an average intensity for each horizontal line of inverted pixels using a peak detection algorithm, to highlight shadows beneath each stacked shelf which are indicated by relatively high intensity pixels;
dividing each row of the inverted b&w image into a plurality of horizontally spaced divisions using at least one Probabilistic Hough Line Detection algorithm to identify images of individual products (product images) on each stacked shelf; and
mapping the product images to the aggregated image and highlighting each of the product images in the aggregated image to illustrate a total horizontal distance occupied by each product on the stacked shelves.

2. The camera system of claim 1, wherein said guide comprises a guideline generated by said GUI.

3. The camera system of claim 2, wherein the edge demarcation comprises at least one blurred edge portion added to the captured first image to create the first modified image.

4. The camera system of claim 1, further comprising a color matching module including a stored program executable by the processor to match colors in the second image with the first modified image to help align and overlap said common portions.

5. The camera system of claim 4, wherein the color matching module is configured to highlight the matched colors in said common portions to help align and overlap said common portions.

6. The camera system of claim 1, configured to repeat said (i) through (v) wherein said first image and said second image comprise an N^{th} image and an N+1^{th} image, respectively, to form said aggregated image.

7. The camera system of claim 1, configured to subdivide each of the plurality of horizontally spaced divisions using said at least one Probabilistic Hough Line Detection algorithm to identify additional product images on each stacked shelf.

8. The camera system of claim 7, configured to apply an interest point detection algorithm to identify additional product images on each stacked shelf.

9. The camera system of claim 1, configured to employ at least one logo detection algorithm to identify trademarks and/or logos in the product images.

10. The camera system of claim 9, configured to highlight each identified product by placing a box around each of the product images.

11. A method for capturing and stitching together multiple stacked shelf images for generating and displaying share-of-shelf information, the method comprising:
(a) providing a camera system including:
a body having a hand-held form factor;
an electronic image capture device having a field of vision, an image display device, a storage device, and a processor, disposed within said body, the processor communicably coupled to the image capture device, the image display device, and the storage device;
(b) configuring the display device to (i) display a first image of a first horizontal stacked shelf portion disposed within the field of vision;
(c) configuring a graphical user interface (GUI) module to (ii) superimpose a GUI with the first image in the display device, and to include at least one guide disposed in fixed relation to said body, wherein the body is movable to align the first image with the guide;
(d) configuring the system to (iii) capture the first image upon alignment of the first image with the guide, and to add at least one edge demarcation to the captured first image to create a first modified image, and to store the first modified image in the storage device;
(e) configuring the GUI, in response to storage of the first modified image, to (iv) display the edge demarcation of the first modified image in the display device along with the guide and a second image of a second horizontal stacked shelf portion disposed within the field of vision, the second horizontal stacked shelf portion being adjacent to the first horizontal stacked shelf portion, wherein the edge demarcation and the guide are usable to align and overlap common portions of the second image with the first modified image prior to capture of the second image;
(f) configuring the system to (v) capture the second image upon alignment of the second image with the guide and with the edge demarcation of the first modified image, to create a second modified image, and to store the second modified image in the storage device, wherein the first modified image and the second modified image form an aggregated image; and
(g) providing the system with a product identification module including a stored program executable by the processor, the stored program configured to identify individual products within the aggregated image by:
converting any colored image portions within the aggregated image into black and white to generate a black and white version of the aggregated image (b&w image);
inverting pixels of the b&w image to create an inverted black and white version of the aggregated image (inverted b&w image), and computing an average intensity for each horizontal line of inverted pixels using a peak detection algorithm, to highlight shadows beneath each stacked shelf which are indicated by relatively high intensity pixels;
dividing each row of the inverted b&w image into a plurality of horizontally spaced divisions using at least one Probabilistic Hough Line Detection algorithm to identify images of individual products (product images) on each stacked shelf; and
mapping the product images to the aggregated image and highlighting each of the product images in the aggregated image to illustrate a total horizontal distance occupied by each product on the stacked shelves.

12. The method of claim 11, wherein said guide comprises a guideline generated by said GUI.

13. The method of claim 12, wherein the edge demarcation comprises at least one blurred edge portion added to the captured first image to create the first modified image.

14. The method of claim 11, further comprising providing a color matching module including a stored program executable by the processor to match colors in the second image with the first modified image to help align and overlap said common portions.

15. The method of claim 14, comprising configuring the color matching module to highlight the matched colors in said common portions to help align and overlap said common portions.

16. The method of claim 11, comprising configuring the camera system to repeat said (i) through (v) wherein said first image and said second image comprise an N^{th} image and an N+1^{th} image, respectively, to form said aggregated image.

17. The method of claim 11, comprising configuring the camera system to subdivide each of the plurality of horizontally spaced divisions using said at least one Probabilistic Hough Line Detection algorithm to identify additional product images on each stacked shelf.

18. The method of claim 17, comprising configuring the camera system to apply an interest point detection algorithm to identify additional product images on each stacked shelf.

19. The method of claim 11, comprising configuring the camera system to employ at least one logo detection algorithm to identify trademarks and/or logos in the product images.

20. The method of claim 19, comprising configuring the camera system to highlight each identified product by placing a box around each of the product images.
